(19) United States
(12) Patent Application Publication
(10) Pub. No.: US 2006/0281527 A1
(43) Pub. Date: Dec. 14, 2006

(54) Gaming system, device and method for providing a slot machine game incorporating multiple pay line-based jackpots

(75) Inventors: Vladimir Dunaevsky, Toronto (CA); Sergiy Rozkin, Toronto (CA); Serguei Bourenkov, Toronto (CA)

Correspondence Address: BERESKIN AND PARR, 40 KING STREET WEST, BOX 401, TORONTO, ON, M5H 3Y2, CA

(73) Assignee: CryptoLogic Inc., Toronto (CA)

(21) Appl. No.: 11/140,899

(22) Filed: Jun. 1, 2005

(51) Int. Cl. A63F 13/00

(52) U.S. Cl. 463/20

(57) ABSTRACT

A gaming system, device, and method of providing a slot machine game to a user on the gaming device, incorporating multiple jackpots, each specifically associated with at least one pay line. After a wager from a user to play at least one selected pay line is received, symbols are displayed on the gaming device. For each selected pay line, it is determined from the displayed symbols whether a jackpot condition is satisfied from the displayed symbols. Where the jackpot condition is satisfied, the user is awarded at least a portion of the jackpot specifically associated with the respective selected pay line.

### FIELD OF THE INVENTION

Embodiments of the invention relate generally to gaming devices, and more specifically, to a gaming system, device, and method for providing a slot machine game.

### BACKGROUND OF THE INVENTION

Slot machines are gaming devices that were originally designed primarily as mechanical machines that incorporated a number of physical reels that rotated about a central axis, and which were operated by a user inserting coins into a slot and pulling down on a long handle.

Slot machine-like games of chance are now played on a wide variety of other types of gaming devices, including for example: electro-mechanical machines incorporating physical symbol-carrying reels that are operated by the pull of a handle or the push of a button; video terminals comprising a display for simulated virtual symbol-carrying reels, and which are operated by the pull of a handle or the push of a button; gaming terminals incorporating a touch screen display providing simulated virtual symbol-carrying reels and user-selectable images of buttons or other game initiation mechanisms, operated by selecting a button image or other game initiation mechanism on the screen by a user; and computing devices, possibly connected to a server over a communication network, within which a software application executes that is programmed to display simulated virtual symbol-carrying reels to a user, and which is operated by providing user input via an input device coupled to the computing device (e.g. whereby the device detects certain keystrokes, or a mouse click when a cursor has been placed on an image of a displayed button or other game initiation mechanism, etc.).

Some of these gaming devices upon which slot machine-like games of chance are played provide means to accept a physical monetary deposit from the user in the form of coins, gaming tokens, paper currency or other currency equivalents, which can then be converted into playing credits. Other gaming devices permit playing credits to be accrued in other ways, by allowing credits to be purchased through an online payment system, for example.

Slot machine-like games (referred to herein more generally as slot machine games) played on these gaming devices are typically characterized by the display of multiple reels or columns, each upon which different symbols (e.g. fruit, “7”s, bars, special jackpot icons, etc.) are distributed. One or more pay lines that span the individual reels or columns are typically defined, and wagers may be placed by users on either all or a subset of the defined pay lines. After a wager by the user of the gaming device is made, symbols are displayed to the user, typically after a rearrangement of previously displayed symbols is performed or simulated. For example, the rearrangement may be effected by spinning symbol-carrying reels or by simulating the spinning of symbol-carrying reels, or by scrambling or otherwise changing the symbols being displayed in some other manner, until a steady-state is achieved in which reels cease to spin or in which the display of symbols otherwise stops changing.

Typically, if a predetermined combination of symbols is displayed in a pay line selected for play by a user who has placed a wager on the outcome of the pay line, a payout is then awarded to the user in accordance with a payout table. The payout table is a schedule that associates each of a number of different predetermined combinations of symbols with a number of credits to be paid out to the user if the specific respective combination is displayed in a selected pay line, and in some cases, a multiplication factor may also be applied in association with particular combinations.

### SUMMARY OF THE INVENTION

Embodiments of the invention relate generally to a novel and inventive slot machine game, which may provide greater attraction to users of gaming devices as compared to known slot machine games.

In one broad aspect, there is provided a method of providing a slot machine game to a user on a gaming device, comprising the steps of: a) identifying a plurality of pay lines on a display; b) associating each of a plurality of jackpots with at least one of the plurality of pay lines; c) receiving a wager from the user identifying one or more selected pay lines of the plurality of pay lines; d) displaying a plurality of symbols on the display in response to the wager; e) for each selected pay line, determining if at least one of one or more predetermined payout conditions is satisfied from the symbols displayed in the respective selected pay line and awarding the user when at least one predetermined payout condition is satisfied; wherein step e) comprises, for each selected pay line having a jackpot associated therewith, determining whether a jackpot condition is satisfied from the symbols displayed in the respective selected pay line and awarding to the user at least a portion of the jackpot associated with the respective selected pay line if the jackpot condition is satisfied.

In another broad aspect, there is provided a computer-readable medium upon which a plurality of executable instructions are stored, the instructions for performing steps of a method of providing a slot machine game to a user on a gaming device in an embodiment of the invention.

In another broad aspect, there is provided a gaming device operable by a user comprising: display means adapted to display a plurality of symbols and identify a plurality of pay lines; and game control means adapted to detect a wager received from the user identifying one or more selected pay lines of the plurality of pay lines, control symbols displayed on the display means, and for each selected pay line, determine if at least one or more predetermined payout conditions is satisfied from the symbols displayed in the respective selected pay line and award the user when at least one predetermined payout condition is satisfied; wherein the game control means is further adapted to associate each of a plurality of jackpots with at least one of the plurality of pay lines, and for each selected pay line having a jackpot associated therewith, determine whether a jackpot condition is satisfied from the symbols displayed in the respective selected pay line and award the user at least a portion of the jackpot associated with the respective selected pay line if the jackpot condition is satisfied.

In another broad aspect, there is provided a gaming system comprising a game server, and coupled thereto at least one gaming device of an embodiment of the invention.

### BRIEF DESCRIPTION OF THE DRAWINGS

For a better understanding of embodiments of the invention, and to show more clearly how they may be carried into effect, reference will now be made, by way of example, to the accompanying drawings in which:

FIGS. 1A-1C are schematic diagrams illustrating a number of example gaming system configurations;

FIG. 2 is a schematic diagram illustrating an example configuration of a 3×5 matrix of display positions for symbols with multiple pay lines identified thereon;

FIG. 3 is a diagram illustrating a display of symbols of an example slot machine game outcome, in which multiple jackpots are incorporated in the slot machine game provided in accordance with at least one embodiment; and

FIG. 4 is a flowchart illustrating the steps in a method of providing a slot machine game to a user on a gaming device in accordance with at least one embodiment.

### DETAILED DESCRIPTION

Users who play on gaming devices regularly may quickly tire of particular games. To add interest to games played by users of such gaming devices, additional features, bonuses, jackpots, and free games, for example, can be incorporated into these games.

In particular, in order to entice users to play certain slot machine games, some known slot machine games provide users with the opportunity to win a jackpot, typically some significant monetary award, if a predetermined combination of symbols specifically defining a jackpot combination is displayed in any pay line selected for play by a user. For instance, in one exemplary game, if any selected pay line displays all “wild card” or special “jackpot” symbols, the user of the gaming device on which the slot machine game is being played would win the jackpot, which is associated with that jackpot combination.

In many known slot machine games incorporating a jackpot, the jackpot typically increases each time the slot machine game is played. The increase is usually funded with a small portion of each wager made in the slot machine game, which is added to the jackpot.

As a further example, designed on the premise that some users will be more attracted to playing a particular slot machine game as the jackpot grows larger, some known slot machine games provide users with the opportunity to win a “progressive” jackpot. The offering of a progressive jackpot typically requires that contributions to the jackpot be made by multiple gaming devices, typically connected in a network of gaming devices in which a central game server is employed to monitor the value of the progressive jackpot at any given time. A user of any of the multiple gaming devices in the network would typically be eligible to win the progressive jackpot, which can grow quickly depending on the size of the network and the collective number of games being played on the gaming devices in the network.

Embodiments of the invention relate generally to a novel and inventive slot machine game, which may provide greater attraction to users of gaming devices as compared to known slot machine games, such as those described above.

The embodiments described herein are directed to a slot machine game in which multiple jackpots are offered, and more specifically, in which individual jackpots are associated with one or more individual pay lines.

By providing users with a slot machine game offering multiple jackpots rather than merely a single jackpot, some users may feel that it is easier to win a jackpot or that it is possible to win a jackpot more frequently. Some users may be attracted to the opportunity to play for different jackpots without the need to switch between games or gaming devices. In embodiments where a user may win more than one of the multiple jackpots in any given game instance, the possibility of winning multiple jackpots in a single play may attract certain users. Accordingly, the slot machine game provided in various embodiments will generally have broader appeal as compared to slot machine games offering users the opportunity to win a single jackpot.

Furthermore, by associating individual jackpots with one or more individual pay lines, some users may be attracted to the freedom of choice that the slot machine game of these embodiments will appear to provide. Since a jackpot associated with a pay line can only be won if the user decides to select that particular pay line for play by providing the requisite wager, the users themselves can specify which particular jackpot(s) they want to play for in any given game instance.

For example, consider embodiments where each individual jackpot increases independently of the other individual jackpots. The rate at which a given individual jackpot increases may depend on how often the pay line with which that jackpot is associated is selected for play. A user has the freedom to select for play only the specific pay lines for which the associated jackpot is sufficiently attractive to that user, and to not select for play the specific pay lines for which the associated jackpot is not sufficiently attractive to that user. Furthermore, as the individual jackpots for particular pay lines increase (or decrease as the individual jackpots get paid out), this may affect a user's desire to play certain pay lines, and the user's decision of which pay line(s) to select for play may change accordingly.

As each individual jackpot of the multiple jackpots made available to be won by users is associated with at least one pay line, each jackpot is also referred to herein as a “pay line-based jackpot”.

These and other features of various embodiments of the invention are discussed in greater detail below with reference to the appended Figures.

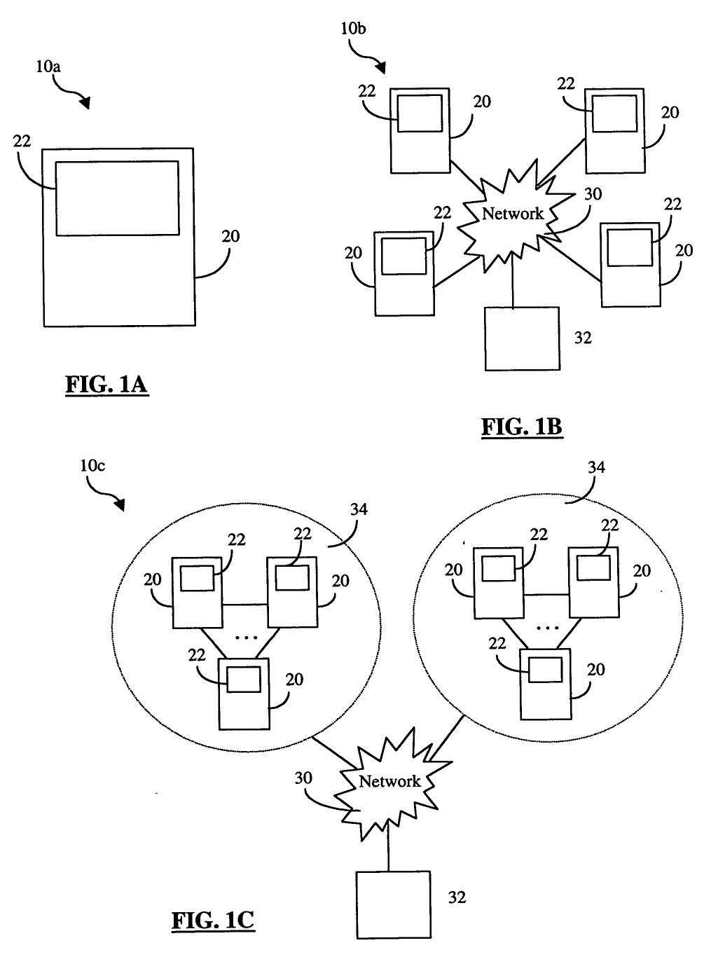

Referring to FIGS. 1A to 1C, schematic diagrams illustrating a number of example gaming system configurations are provided.

In FIG. 1A, one example configuration in which gaming system 10a comprises a single gaming machine or device 20 is shown. Gaming device 20 comprises a display 22, in which symbols of a slot machine game and other game indicia may be displayed. It will be understood that gaming device 20 will also include other components not shown in the Figures.

In one embodiment of the invention, contributions to multiple jackpots of the slot machine game being played on gaming device 20 are derived only from wagers received from the play of the slot machine game on the single gaming device 20 of gaming system 10a.

In FIG. 1B, another example configuration in which gaming system 10b comprises multiple gaming devices 20 is shown. Each gaming device 20 comprises a display 22, in which symbols of a slot machine game and other game indicia may be displayed.

In one embodiment of the invention, contributions to the multiple jackpots of the slot machine game being played on a given gaming device 20 in gaming system 10b are derived from wagers received from users playing the slot machine game on any of multiple gaming devices 20 coupled together in a network 30. In this embodiment, the values of the multiple jackpots offered on each gaming device 20 are maintained by a central game server 32 in network 30. Central game server 32 accumulates, updates, and broadcasts the values of the multiple jackpots to the connected gaming devices 20 in network 30.

Gaming devices 20 in a gaming system (e.g. system 10b) may reside in the same physical location (e.g. a casino facility). Alternatively, gaming devices 20 in a gaming system may be distributed across multiple physical locations.

In a further example configuration as shown in FIG. 1C, gaming system 10c comprises multiple subnetworks 34 of gaming devices 20, where each subnetwork 34 may be established at a different physical location (e.g. one of a number of casino facilities). The subnetworks 34 are coupled together in a network 30.

In one embodiment of the invention, contributions to the multiple jackpots of the slot machine game being played on a given gaming device 20 in gaming system 10c are derived from wagers received from users playing the slot machine game on any of multiple gaming devices 20 (in any subnetwork 34) coupled together in network 30. In this embodiment, the multiple jackpots offered on each gaming device 20 are maintained by a central game server 32 in network 30. Central game server 32 accumulates, updates, and broadcasts the values of the multiple jackpots to the connected gaming devices 20 in network 30.

In view of the example configurations of gaming systems 10b, 10c and other similar configurations, progressive jackpots may be maintained where contributions originate from the play of a slot machine game at any of multiple gaming devices 20. In at least one embodiment, the value of each of the individual pay line-based jackpots provided on any given gaming device 20 will fluctuate independently of the value of the other individual pay line-based jackpots provided on the same gaming device, and therefore, each of the multiple jackpots may be considered to be a separate progressive jackpot in these embodiments.

In one embodiment, gaming devices 20 in gaming system 10b and/or 10c may form a wide area network, where the gaming devices 20 are 10 personal computers connected together via the Internet, an Intranet, or other network, and monitored by central game server 32.

It will be understood that gaming devices 20 on which methods of providing a slot machine game can be implemented are not limited to traditional mechanical slot machines, but may also include, for example, electromechanical machines, video terminals, gaming terminals with touch screens, and computing devices. As further examples, gaming devices 20 may include interactive televisions, wireless mobile devices, and any other communication devices or gaming devices comprising a display for providing a graphical representation of a virtual slot machine to users and processing means for performing the steps for playing a slot machine game in accordance with an embodiment of a method of the invention. It will be within the capabilities of the person of ordinary skill in the art to implement such methods on any standard microprocessor-based machine or device by means of appropriate programming.

The configurations illustrated in FIGS. 1A to 1C are provided by way of example only, and other configurations of gaming devices 20 are possible in variant implementations. It will be understood that the functions of the central game server 32 may also be provided on one or more gaming devices 20, for example, and need not exist as a separate device.

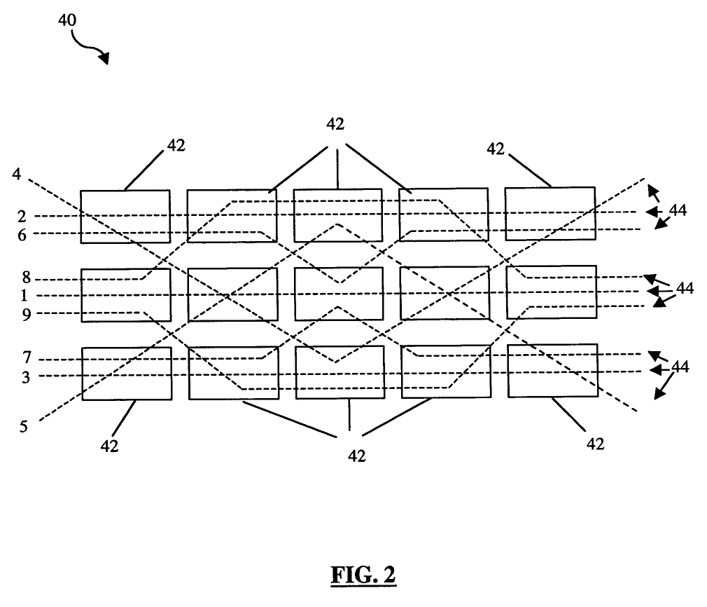

Referring to FIG. 2, a schematic diagram illustrating an example configuration of a 3×5 matrix of display positions for symbols with multiple pay lines identified thereon is shown generally as 40.

Slot machine games played on gaming devices (e.g. gaming device 20 of FIG. 1) are typically characterized by the display of multiple reels or columns, each upon which different symbols are distributed. One or more pay lines (also commonly referred to as “betting lines”) that span the individual reels or columns are typically defined, and wagers may be placed by users on either all or a subset of the defined pay lines. The defined pay lines typically span a predetermined sequence of predetermined display positions. When a steady-state is achieved in the display of symbols, each display position may or may not be occupied by a symbol.

In variant implementations, the display positions that define a given pay line need not be adjacent to one another. As a further example, the display positions may not be predetermined, but may be determined at random and be defined differently for each game instance, in other implementations.

Historically, in a single game instance, only one pay line would be defined, typically comprising a single, horizontal center row of display positions. However, in many currently known slot machine games, a user may wager on multiple pay lines, and/or on specific pay lines as identified by the user. The example of FIG. 2 illustrates a 3×5 matrix of display positions 42, and a set of pay lines 44 (marked as pay lines 1-9 in FIG. 2) defined by various sequences of display positions 42. This example is provided for illustration purposes only, and it will be understood that the number, configuration, and/or layout of display positions 42, can differ in variant implementations of a slot machine game. It will be also understood that the number, configuration, and/or layout of pay lines 44 can differ in variant implementations of a slot machine game.

Users can place a wager by providing the requisite wager amount (e.g. cash, game credits) and identifying one or more selected pay lines. For each selected pay line, it is determined whether a predetermined payout condition is satisfied from symbols displayed in that respective pay line in response to the wager. If the payout condition is satisfied, then the user is provided with an award (“payout”) associated with that payout condition.

Typically, a particular payout condition is satisfied when an associated predetermined combination of symbols is displayed in that pay line. Multiple payout conditions may be defined, each corresponding to a different predetermined combination of symbols and an associated award payable to the user when the respective combination of symbols is displayed in a selected pay line. These combinations and payouts may be defined in a payout table.

Depending on the particular implementation, determinations of whether a predetermined combination of symbols is being displayed in a given pay line may depend on other factors, including whether or not the symbols are displayed in their entirety within each display position of a pay line, and whether or not the symbols are displayed in a requisite order within a sequence of display positions of a pay line, for example.

A jackpot condition may also be defined, which would be satisfied when a predetermined combination of symbols specifically defining the jackpot condition is displayed in that pay line. For example, a slot machine game may be configured to award a jackpot when a special combination of symbols is displayed in a selected pay line (e.g. a sequence of “wild card” symbols or special “jackpot” symbols).

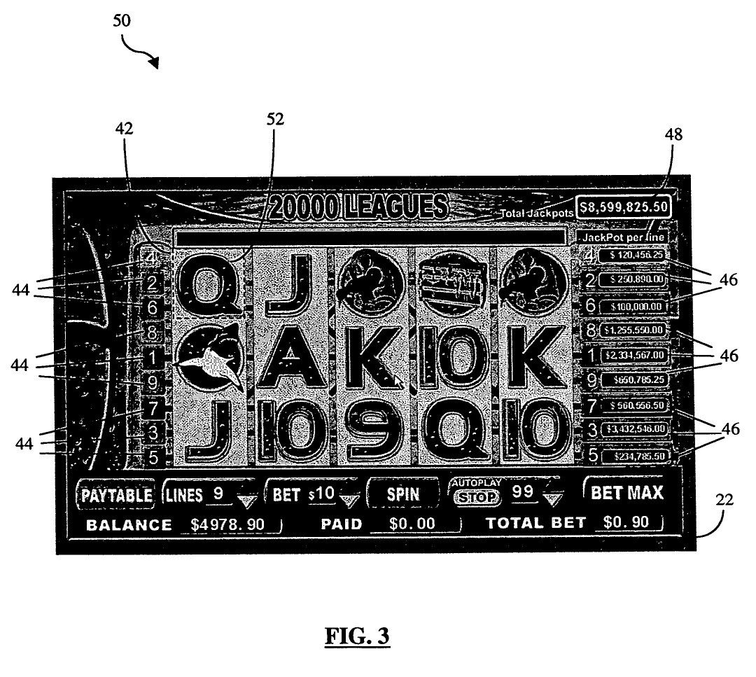

Referring to FIG. 3, a diagram illustrating a display of symbols of an example slot machine game outcome, in which multiple jackpots are incorporated in the slot machine game provided in accordance with at least one embodiment is shown generally as 50.

The diagram shown in FIG. 3 is an example screenshot of a video display used to illustrate a number of features of various embodiments of the invention. It will be understood that this screenshot is provided for illustration purposes only, and that the particular design, graphical, user interface, and other features shown may be omitted or different in variant implementations.

In the outcome of the slot machine game illustrated in this particular example, a steady-state of symbols 52 is shown in a display 22 of a gaming device (e.g. 20 of FIGS. 1A-1C). In this example, after a simulation of spinning reels, a symbol 52 has come to rest in each of 15 display positions 42 (one example is shown in FIG. 3). Nine pay lines 44 have also been identified on the display. In this example, all nine pay lines 44 have been selected for play by the user, but a user may select only a subset of identified pay lines for play in any given game instance.

In one embodiment, each pay line 44 has associated with it one of multiple pay line-based jackpots.

The value of each pay line-based jackpot 46 may be shown to the user in display 22. An identifier of the specific pay line with which the respective jackpot is associated may also be displayed. In embodiments where the pay line-based jackpots 46 change, the updated values may be shown to the user in display 22.

The total value of all of the pay line-based jackpots may also be displayed to the user in display 22, shown at 48, which may enhance user interest in the slot machine game. For example, if a user selects all pay lines with which a pay line-based jackpot is associated for play, and places the requisite wager, in one embodiment, a user may be eligible to win the “total jackpot” (e.g. value shown at 48), which is the sum of the individual pay line-based jackpots 46 available to be won. In embodiments where the pay line-based jackpots 46 change, the updated total value may be shown to the user in display 22.

When the steady-state is achieved, it is determined whether any pay line 44 selected for play by the user satisfies the jackpot condition for that pay line. If the jackpot condition is satisfied, then at least a portion of the pay line-based jackpot 46 for that pay line would be awarded to the user.

In one embodiment, the jackpot condition associated with a pay line 44 is satisfied when a predetermined combination of symbols defining a jackpot combination is displayed in that pay line. The specific combination of symbols that defines a jackpot combination will depend on the particular implementation.

Depending on the particular implementation, determinations of whether a combination of symbols defining a jackpot combination is being displayed in a given pay line may depend on other factors, including whether or not the symbols are displayed in their entirety within each display position of a selected pay line, and whether or not the symbols are displayed in a requisite order within a sequence of display positions of a pay line, for example.

Other types of jackpot conditions associated with pay lines may be defined in variant embodiments. Furthermore, different jackpot conditions may be defined for different pay lines in variant embodiments.

In one embodiment, a user may be permitted to win multiple pay line-based jackpots 46 in a single game instance. For every pay line 44 selected for play where the jackpot condition associated with that pay line is determined to be satisfied, the user may be awarded the pay line-based jackpot 46 for those pay lines. This may attract users who desire the opportunity to win multiple jackpots, or who wish to play for multiple jackpots on the same gaming machine.

As noted above, in one embodiment, the user can potentially win the total jackpot (e.g. if the jackpot combination is attained for all pay lines for which a pay line-based jackpot is associated), for which the total value is shown at 48.

In variant embodiments, a user may be limited to the number of jackpots that may be won or to a maximum amount awardable, even if multiple jackpot conditions (for multiple pay lines) are satisfied.

In one embodiment, multiple jackpot conditions (e.g. associated symbol combinations) are defined for a pay line 44. Each jackpot condition may be associated with a different portion of the same pay line-based jackpot 46. For example, one combination of symbols appearing in a selected pay line may define a jackpot condition that entitles the user to win 10% of the jackpot associated with the selected pay line, while a different combination of symbols appearing in the selected pay line may define a different jackpot condition that entitles the user to win 100% of the jackpot associated with the selected pay line.

It will be understood that where a reference is made herein to a user winning a jackpot or being awarded a jackpot, this does not necessarily mean that the full value of a given jackpot will actually be awarded to the user when the jackpot is won. Typically, a portion of a jackpot that might otherwise be awarded to the user when a jackpot is won is withheld to seed subsequent jackpots and/or collected by an operator of the gaming system, for example.

In one embodiment, a pay line-based jackpot 46 is associated with each pay line 44 identified on display 22 upon which a user may place a wager, as shown in the example of FIG. 3. However, in variant embodiments, some pay lines may not have any pay line-based jackpot associated with it. Furthermore, in variant embodiments, a pay line-based jackpot may be associated with different groups or subsets of pay lines, such that the user may be awarded the jackpot (or a portion thereof) whenever the jackpot condition is satisfied for any of the pay lines in that group or subset.

In one embodiment, each pay line-based jackpot 46 can fluctuate over time. The pay line-based jackpots change dynamically, and are not permanently defined in a payout table, for instance.

In one embodiment, each pay line-based jackpot 46 fluctuates independent of all other pay line-based jackpots 46 provided by the slot machine game. Accordingly, while an operator of the gaming system may initially set each pay line-based jackpot 46 to the same value, over time, the value of the pay line-based jackpots 46 will typically differ in the normal course of play.

As noted above with reference to FIGS. 1B and 1C, in gaming systems where multiple gaming devices are coupled together in a network, fluctuations of individual pay line-based jackpots may be controlled by a central game server. Increases that are to be made to a jackpot as a result of play on a given gaming device are transmitted to the game server for centralized tracking, and jackpot data can be retrieved from the game server to update the values of the jackpots displayed on that gaming device.

In one embodiment, the pay line-based jackpot 46 associated with a given pay line 44 is increased after a wager is received from the user identifying that particular pay line 44 as a selected pay line for play. Generally, the more a particular pay line is selected for play, the higher the jackpot associated with that pay line would grow. This, in turn, may provide a greater attraction to users, who may choose that particular pay line when selecting pay lines to be played, and such play would cause a further increase in the jackpot. Play of the particular pay line may increase at a significant rate, until the jackpot associated with that pay line is won, (at which time the jackpot may be decreased to an initial seed value, for example). The occurrence of this sequence of events may generate excitement and feelings of urgency among users, particularly where the same pay line-based jackpot 46 may be won by any one of multiple users playing concurrently within a network of gaming devices.

Other methodologies and algorithms for controlling the increase and decrease of individual pay line-based jackpots may be employed in variant embodiments.

In variant embodiments, additional features, bonuses and/or free games, for example, may be provided in the slot machine game.

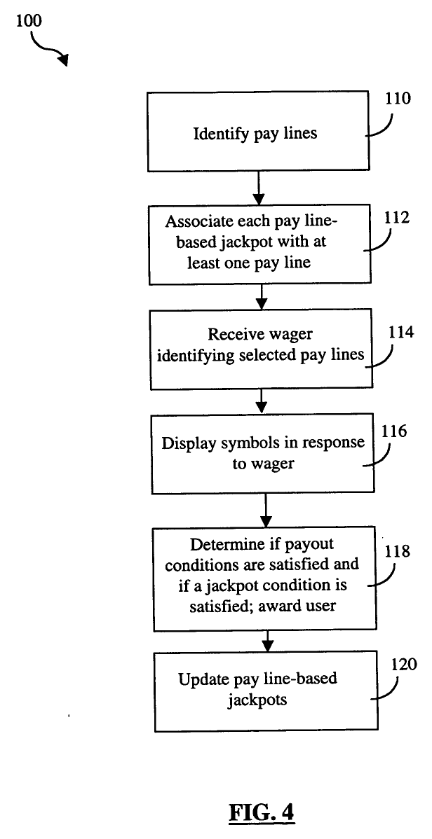

Referring to FIG. 4, a flowchart illustrating the steps in a method of providing a slot machine game to a user on a gaming device in accordance with at least one embodiment is shown generally as 100.

A number of features described with reference to FIG. 4 have been explained in greater detail with reference to the other Figures, and a number of other embodiments of the method of providing slot machine game not explicitly described below will be apparent from the description provided above with reference to the other Figures.

At step 110, multiple pay lines (e.g. 44 of FIGS. 2 and 3) are identified on a display (e.g. 22 of FIGS. 1A-1C, 3).

At step 112, multiple pay line-based jackpots are provided, each of the multiple pay line-based jackpots (e.g. 46 of FIG. 3) being associated with at least one pay line. In one embodiment, jackpot data is retrieved from a game server in this step in order to determine the value of the multiple jackpots. Each jackpot may be optionally associated with different subsets of pay lines, however, in one embodiment, each jackpot is associated with exactly one pay line.

Optionally, the current value of one or more of the multiple pay line-based jackpots and/or the current total value of the multiple jackpots (e.g. 48 of FIG. 3) may be displayed to the user in the display.

At step 114, a wager is received from the user identifying one or more selected pay lines to be played, defining the current game instance. The user may choose to select all of the multiple pay lines identified on the display at step 110 for play, or a subset of those pay lines. The user may be given the option to specify the particular pay lines to be played.

At step 116, symbols (e.g. 52 of FIG. 3) are displayed in a steady-state on the display in response to the wager. Depending on the particular implementation, this may follow a re-arrangement or scrambling of symbols (e.g. through the spinning of reels or a simulation thereof) as provided in known slot machine games.

At step 118, for each selected pay line, it is determined if a predetermined payout condition is satisfied from the symbols displayed at step 116 in the respective selected pay line, and if it is so determined, the user is awarded the associated payout. In one embodiment, a predetermined payout condition for a pay line is satisfied when a predetermined combination of symbols defining the payout combination is displayed in that pay line. Several of such predetermined payout conditions and associated awards will typically be defined in a payout table, and the values of the awards associated with those predetermined payout conditions defined in the payout table will typically be fixed.

Furthermore at this step, for each selected pay line having an associated pay line-based jackpot, it is determined if a jackpot condition is satisfied from the symbols displayed at step 116 in the respective selected pay line, and if it is so determined, the user is awarded at least a portion of the jackpot associated with the respective selected pay line. In one embodiment, the jackpot condition associated with a pay line is satisfied when a predetermined combination of symbols defining a jackpot combination is displayed in that pay line.

While the jackpot combination may be predefined, the values of the pay line-based jackpots are not predefined any may fluctuate, in one embodiment.

A pay line-based jackpot is not a general jackpot that may be won whenever the jackpot combination appears in any arbitrary selected pay line.

Instead, each pay line-based jackpot is associated with at least one specific pay line.

In one embodiment, at step 120, the pay line-based jackpot for each selected pay line is updated. The jackpot for a selected pay line may be increased if the jackpot for the selected pay line was not won in the current game instance, and decreased if the jackpot was won, for example. Data associated with the updated jackpot may be transmitted to a game server (e.g. 32 of FIG. 1B, 1C) in embodiments of the system where the gaming device on which the current game instance is played is connected to other gaming devices in a network (e.g. 30 of FIG. 1B, 1C). Jackpot data may also be retrieved from the game server to update the pay line-based jackpots at this step.

Instructions for performing a method of providing a slot machine game in accordance with embodiments of the present invention may be provided on computer-readable media, which is intended to encompass transmission-type media.

The invention has been described with regard to a number of embodiments. However, it will be understood by persons skilled in the art that other variants and modifications may be made without departing from the scope of the invention as defined in the claims appended hereto.

1. A method of providing a slot machine game to a user on a gaming device, comprising the steps of:
a) identifying a plurality of pay lines on a display;
b) associating each of a plurality of jackpots with at least one of the plurality of pay lines;
c) receiving a wager from the user identifying one or more selected pay lines of the plurality of pay lines;
d) displaying a plurality of symbols on the display in response to the wager;
e) for each selected pay line,
determining if at least one of one or more predetermined payout conditions is satisfied from the symbols displayed in the respective selected pay line and awarding the user when at least one predetermined payout condition is satisfied;
wherein step e) comprises, for each selected pay line having a jackpot associated therewith,
determining whether a jackpot condition is satisfied from the symbols displayed in the respective selected pay line and awarding to the user at least a portion of the jackpot associated with the respective selected pay line if the jackpot condition is satisfied.

2. The method of claim 1, wherein each of the plurality of jackpots is associated with a different subset of pay lines.

3. The method of claim 2, wherein each subset of pay lines is comprised of exactly one pay line.

4. The method of claim 1, wherein the jackpot condition associated with a pay line is satisfied when a predetermined combination of symbols defining a jackpot combination is displayed in that pay line.

5. The method of claim 1, wherein each of the plurality of jackpots has a value that is different from the value of at least one other of the plurality of jackpots.

6. The method of claim 1, further comprising the step of updating the jackpot associated with a pay line after a wager is received from the user identifying that pay line as a selected pay line.

7. The method of claim 6, further comprising the step of transmitting data pertaining to the updated jackpot associated with that pay line to a game server.

8. The method of claim 7, further comprising the steps of retrieving jackpot data from the game server, and updating one or more of the plurality of jackpots based on the retrieved jackpot data.

9. The method of claim 1, further comprising the step of displaying a value for one or more of the plurality of jackpots on the display.

10. The method of claim 1, further comprising the step of displaying a value of a total jackpot on the display, wherein the value of the total jackpot is the sum of the values of the plurality of jackpots.

11. A computer-readable medium upon which a plurality of executable instructions for performing the method of providing a slot machine game to a user on a gaming device are stored as claimed in claim 1.

12. A gaming device operable by a user comprising:
display means adapted to display a plurality of symbols and identify a plurality of pay lines; and
game control means adapted to detect a wager received from the user identifying one or more selected pay lines of the plurality of pay lines, control symbols displayed on the display means, and for each selected pay line, determine if at least one or more predetermined payout conditions is satisfied from the symbols displayed in the respective selected pay line and award the user when at least one predetermined payout condition is satisfied;
wherein the game control means is further adapted to associate each of a plurality of jackpots with at least one of the plurality of pay lines, and for each selected pay line having a jackpot associated therewith, determine whether a jackpot condition is satisfied from the symbols displayed in the respective selected pay line and award the user at least a portion of the jackpot associated with the respective selected pay line if the jackpot condition is satisfied.

13. The gaming device of claim 12, wherein each of the plurality of jackpots is associated with a different subset of pay lines.

14. The gaming device of claim 13, wherein each subset of pay lines is comprised of exactly one pay line.

15. The gaming device of claim 12, wherein the jackpot condition associated with a pay line is determined by the game control means to be satisfied when a predetermined combination of symbols defining a jackpot combination is displayed in that pay line on the display means.

16. The gaming device of claim 12, wherein each of the plurality of jackpots has a value that is different from the value of at least one other of the plurality of jackpots.

17. The gaming device of claim 12, wherein the game control means is further adapted to increase the jackpot associated with a pay line after a wager is received from the user identifying that pay line as a selected pay line.

18. The gaming device of claim 17, wherein the game control means is adapted to transmit the value of the increased jackpot associated with that pay line to a game server.

19. The gaming device of claim 18, wherein the game control means is further adapted to retrieve jackpot data from the game server, and update one or more of the plurality of jackpots based on the retrieved jackpot data.

20. The gaming device of claim 12, wherein the game control means is further adapted to display a value for one or more of the plurality of jackpots on the display means.

21. The gaming device of claim 12, wherein the game control means is further adapted to display a value of a total jackpot on the display means, wherein the value of the total jackpot is the sum of the values of the plurality of jackpots.

22. The gaming device of claim 12, wherein the display means is a video display.

23. The gaming device of claim 22, wherein the video display is adapted to display a simulation of a plurality of rotatable reels each carrying a plurality of symbols.

24. The gaming device of claim 12, wherein the display means includes a plurality of rotatable reels, each reel carrying a plurality of symbols.

25. A gaming system comprising a game server and one or more gaming devices coupled thereto, wherein each of the one or more gaming devices is a gaming device as claimed in claim 12.
